(19) United States
(12) Patent Application Publication
(10) Pub. No.: US 2026/0340058 A1
(43) Pub. Date: Oct. 29, 2026

(54) METHOD AND SYSTEM FOR PROVIDING SEARCH SERVICES

(71) Applicant: NAVER CORPORATION, Seongnam-si (KR)

(72) Inventors: Jun Soo JEONG, Seongnam-si (KR); Hee Jae YIM, Seongnam-si (KR); Seul Gi OHK, Seongnam-si (KR); Yeong Jong JEONG, Seongnam-si (KR); Jin Han PARK, Seongnam-si (KR); Min Gyu KIM, Seongnam-si (KR); Jae Yoon KIM, Seongnam-si (KR); Wan LEE, Seongnam-si (KR); Ga Ram LEE, Seongnam-si (KR); Sun Min OH, Seongnam-si (KR); Jeong Yub LEE, Seongnam-si (KR)

(73) Assignee: NAVER CORPORATION, Seongnam-si (KR)

(21) Appl. No.: 19/405,938

(22) Filed: Dec. 2, 2025

(30) Foreign Application Priority Data
Apr. 24, 2025 (KR) 10-2025-0054012

(51) Int. Cl. G06F 16/9538

(52) U.S. Cl. CPC G06F 16/9538

(57) ABSTRACT

A method of providing search services may include: receiving a search term from a user terminal; searching for content corresponding to the search term, using a search engine; providing the content as a search result for the search term in a certain area of a service page; and providing a feed including feed items linked to a recommended search keyword having relevance to the search term, in an area different from the certain area of the service page.

### CROSS REFERENCE TO RELATED APPLICATION

The present application claims priority to Korean Patent Application No. 10-2025-0054012, filed Apr. 24, 2025, the entire contents of which are hereby incorporated by reference in its entirety.

### BACKGROUND

### Field

The present disclosure relates to methods and systems for providing search services.

### Description of the Related Art

With advancements in technology, the use of electronic devices is increasing, and electronic devices are being actively used for the purpose of searching for various pieces of information.

According to a traditional method in the past, in order to search for desired information, users may use documents such as books, magazines, and newspapers made of paper. However, recently, due to the spread of the Internet, most users may use electronic devices connected to the Internet rather than documents made of paper in order to search for information.

Encouraged by such a trend, various search services are being released to provide information required by users. Such search services may provide not only passive services that search for information on search terms input by users, but also active services that provide information on various topics of interest to unspecified multiple users.

As an example, recommended keywords may be selected for a document or a user group and information may be provided to users based on the recommended keywords. As such, in the field of search services, there is an interest in active services that find interests of users and provide information on the same to users.

### SUMMARY

Some example embodiments provide methods and systems for providing search services capable of providing a recommended search keyword by reflecting a user's interest in real time.

Some example embodiments are directed to providing methods and systems for providing search services capable of exposing keywords of various topics to a user and naturally providing a transition to diverse content.

In some example embodiments, a method of providing search services may include: receiving a search term from a user terminal; searching for content corresponding to the search term, using a search engine; providing the content as a search result for the search term in a certain area of a service page; and providing a feed including feed items linked to a recommended search keyword having relevance to the search term in an area different from the certain area of the service page.

In some example embodiments, a system for providing search services may include a memory and at least one processor, and the memory and the processor may cooperate to receive a search term from a user terminal, search for content corresponding to the search term using a search engine, provide the content as a search result for the search term in a certain area of a service page, and provide a feed including a feed item linked to a recommended search keyword having relevance to the search term in an area different from the certain area of the service page.

In some example embodiments, a program is executed by one or more processes in an electronic device, and stored in a non-transitory computer-readable recording medium. The program may include instructions to perform: receiving a search term from a user terminal; searching for content corresponding to the search term, using a search engine; providing the content as a search result for the search term in a certain area of a service page; and providing a feed including feed items linked to a recommended search keyword having relevance to the search term in an area different from the certain area of the service page.

The method and system for providing search services according to some example embodiments may support information exploration that reflects a user's query intent in real time to be possible, by receiving a search term from a user terminal, searching for content corresponding to the search term, using a search engine, and providing the content as a search result for the search term in a certain area of a service page.

Further, the method and system for providing search services according to some example embodiments may jointly provide a feed including a feed item linked to a recommended search keyword having relevance to the search term in an area different from the certain area of the service page, so that a user may be provided not only with content corresponding to the search term that the user himself or herself has input, but also with exploratory paths to various related topics expandable from the search term.

Furthermore, the method and system for providing search services according to some example embodiments, based on real-time content consumption data of a user, may analyze a context of content within a feed that the user is currently exploring, and provide a recommended search keyword matching the same in real time, so that the user may continuously maintain an exploration flow and easily access information corresponding to the user's real-time interest.

### BRIEF DESCRIPTION OF THE DRAWINGS

FIG. 1 is a block diagram for describing a system for providing search services according to an example embodiment.

FIG. 2 is a flowchart for describing a method of providing search services according to an example embodiment.

FIGS. 3A and 3B are conceptual diagrams for describing a feed item according to an example embodiment.

FIG. 4 is a conceptual diagram for describing a recommended search keyword according to an example embodiment.

FIGS. 5A to 5D, 6, 7A to 7C, 8A to 8C, 9A and 9B are conceptual diagrams for describing a feed according to an example embodiment.

### DETAILED DESCRIPTION

Hereinafter, some example embodiments will be described in detail with reference to the accompanying drawings. The same or similar constituent elements are assigned with the same reference numerals regardless of reference numerals, and the repetitive description thereof will be omitted. The suffixes “module”, “unit”, “part”, and “portion” used to describe constituent elements in the following description are used together or interchangeably in order to facilitate the description, but the suffixes themselves do not have distinguishable meanings or functions. In addition, in the description of the example embodiment disclosed in the present specification, the specific descriptions of publicly known related technologies will be omitted when it is determined that the specific descriptions may obscure the subject matter of the example embodiment disclosed in the present specification. In addition, it should be interpreted that the accompanying drawings are provided only to allow those skilled in the art to easily understand the embodiments disclosed in the present specification, and the technical teachings disclosed in the present specification is not limited by the accompanying drawings, and includes all alterations, equivalents, and alternatives that are included in the teachings and the technical scope of the example embodiments.

The terms including ordinal numbers such as “first,” “second,” and the like may be used to describe various constituent elements, but the constituent elements are not limited by the terms. These terms are used only to distinguish one constituent element from another constituent element.

When one constituent element is described as being “coupled” or “connected” to another constituent element, it should be understood that one constituent element can be coupled or connected directly to another constituent element, and an intervening constituent element can also be present between the constituent elements. When one constituent element is described as being “coupled directly to” or “connected directly to” another constituent element, it should be understood that no intervening constituent element exists between the constituent elements.

Singular expressions include plural expressions unless clearly described as different meanings in the context.

In the present application, it should be understood that terms “including” and “having” are intended to designate the existence of characteristics, numbers, steps, operations, constituent elements, and components described in the specification or a combination thereof, and do not exclude a possibility of the existence or addition of one or more other characteristics, numbers, steps, operations, constituent elements, and components, or a combination thereof in advance.

Some example embodiments relate to a method and system for providing search services, which are capable of identifying a user's interest and providing customized information to a user by reflecting the user's interest in real time.

Here, a search service device a service that provides information corresponding to a search term received from a user.

For example, the search service according to some example embodiments is accessible through a communication network from a user's electronic device (hereinafter, referred to as “user terminal”). Here, the communication network is not particularly limited in its type.

Further, the search service may be provided through a browser (or a web browser), a program, an application, or the like, and example embodiments are not limited to any particular form in which the search service is provided.

The search service according to some example embodiments may perform a role of providing information that a user is curious about, by searching for information corresponding to a search term input from the user terminal, and providing a search result to the user terminal.

In this case, in a system for providing search services, a search signal corresponding to the search term input from the user terminal is received, and the system for providing search services may be configured to search for information corresponding to the received search signal.

In the user terminal, a search term may be input in order to search for information, and such a search term may correspond to visual information (e.g., text, number, image, etc.) input on a search area included in a page (e.g., a web page, an execution screen of a program, an execution screen of an application, etc.) for providing the search service according to some example embodiments.

Further, the search term is not necessarily limited to being input in a form of visual information, and may also be input in other forms of information such as voice. For such other forms of information, the system for providing search services according to some example embodiments may provide a proper interface for receiving various forms of information as a search term.

Hereinafter, for the convenience of the description, information input from the user terminal for searching for information in the search service according to some example embodiments shall be referred to as “search term”.

Meanwhile, in the system for providing search services according to some example embodiments, information corresponding to a search result that is searched as information corresponding to a search term shall be referred to as “content”.

In some example embodiments, the content may mean online information that is collected or extracted by a search engine as a search result corresponding to a search term input by a user.

Here, the type of the content is not particularly limited, as long as it is information in a form representable by the user terminal. For example, the content may include a web page, a news article, a blog post, a community post, a video, product information, weather information, an e-commerce review, and a map.

Further, in the system for providing search services according to some example embodiments, a “feed” may be provided to the user terminal as a tool for inducing a user's search and content exploration.

In some example embodiments, the feed means a content stream including a plurality of feed items, and may be provided in a scrollable list format. In some example embodiments, the feed may be provided to expand content exploration centered on a user's real-time interest.

Further, a feed item is a single unit content object constituting the feed, and may be generated based on an online post (e.g., a blog post, a community post, a video, a news article, a social media post, etc.). At least a part of such online posts may include the above-described content.

Hereinafter, more detailed descriptions will be made of a method and system for providing search services according to some example embodiments, together with the accompanying drawings.

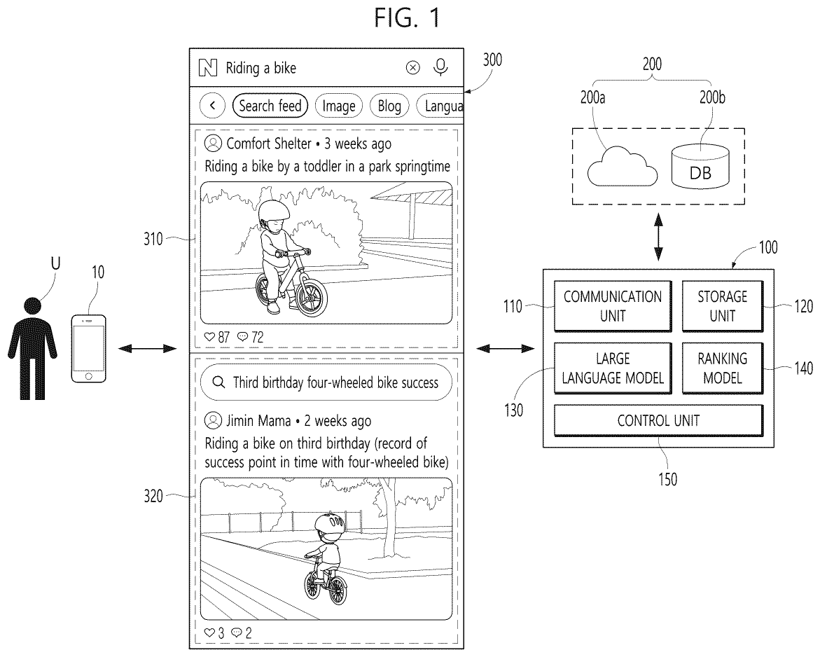

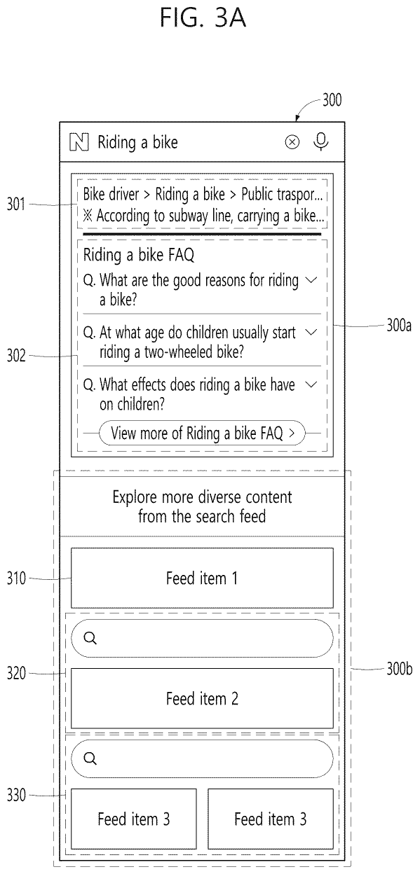

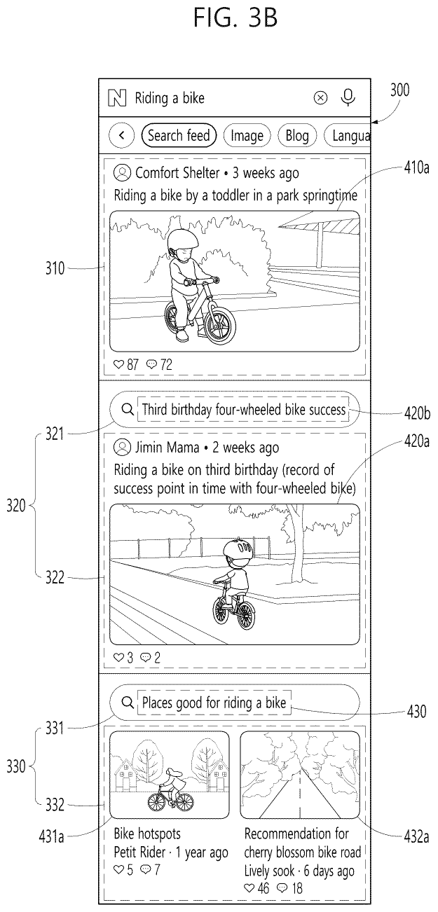

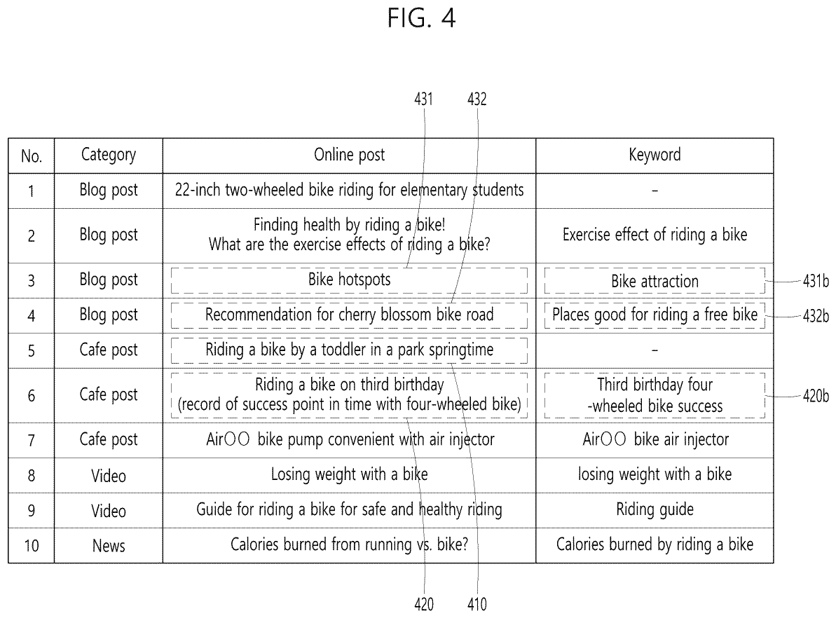

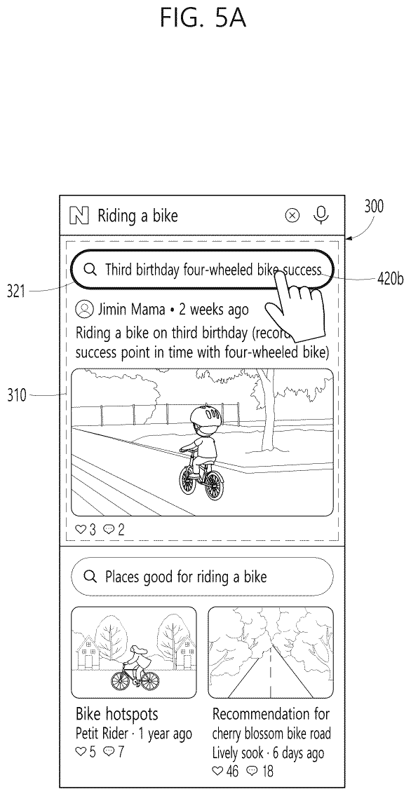

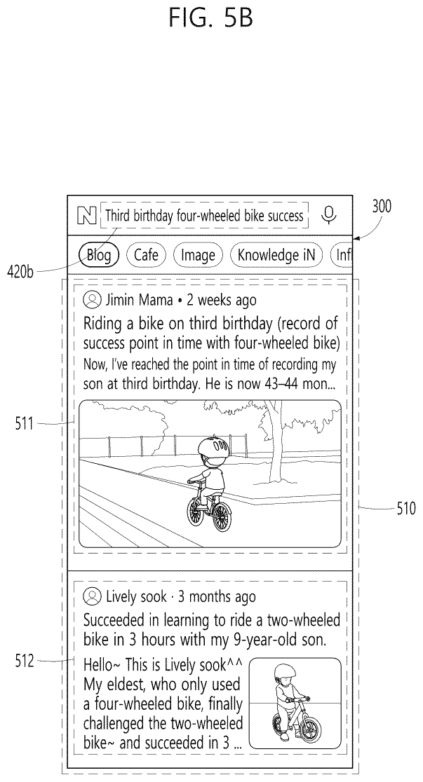

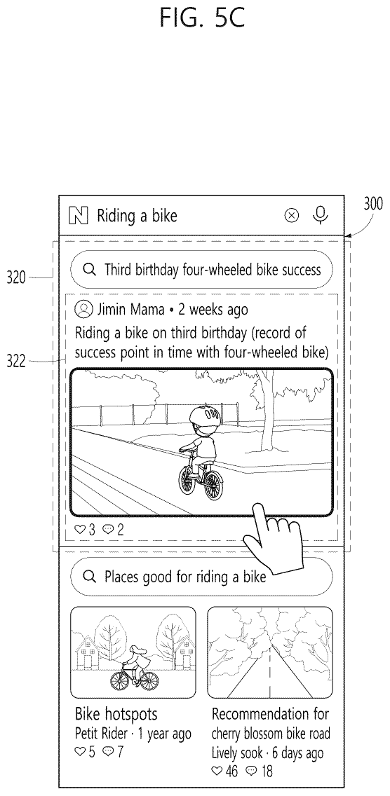

FIG. 1 is a block diagram for describing a system for providing search services according to some example embodiments. FIG. 2 is a flowchart for describing a method of providing search services according to some example embodiments, FIGS. 3A and 3B are conceptual diagrams for describing a feed item provided in some example embodiments, FIG. 4 is a conceptual diagram for describing a recommended search keyword provided in some example embodiments, and FIGS. 5A to 5D, 6, 7A to 7C, 8A to 8C, 9A and 9B are conceptual diagrams for describing a feed provided in some example embodiments. In some example embodiments, the recommended search keyword may also be referred to as a recommended keyword.

As illustrated in FIG. 1, a system 100 for providing search services according to some example embodiments may include at least one of a communication unit 110, a storage unit 120, a large language model 130, a ranking model 140, or a control unit 150.

The communication unit 110 may be configured to communicate with a user terminal 10. In some example embodiments, the type of the user terminal 10 is not limited, and it suffices that the user terminal 10 is capable of accessing a search service provided by the system 100 for providing search services according to some example embodiments. For example, the types of the user terminal 10 may include a smartphone, a tablet PC, a laptop, and a desktop computer. However, example embodiments are not limited thereto. As illustrated, a service page 300 according to the search service provided by the system 100 for providing search services according to some example embodiments may be provided to the user terminal 10. Accordingly, a user may use the search service through such a service page 300 provided, by the system 100, to the user terminal 10.

The communication method of the communication unit 110 is not particularly limited in its type, and may be configured to perform communication with a communication target using at least one of a wired or wireless method.

The storage unit 120 may be configured to store various types of information related to the search service. In some example embodiments, the storage unit 120 may be referred to as a memory, a database, and the like.

The storage unit 120 may be configured such that user information related to a user who uses the search service according to some example embodiments may be stored.

Here, the user information may be user account information registered in the search service or in a search service page that provides the search service, according to some example embodiments. The search service or the search service page that provides the search service may be configured to allow log-in based on the user account.

The user information may further include various types of information such as the user's gender, age, residential area, interest, hobby, and occupation.

Further, the user information may further include user history information. The user history information may be understood as information on a user's usage history of the search service. For example, the user history information may include search history data of the user (e.g., a search term searched in the user terminal) and content consumption data of the user.

Here, the “content consumption data” may include at least one of selection information on a specific feed item selected from among a plurality of feed items provided on the service page 300 in the user terminal 10, and residence time and interaction information in a corresponding online post provided based on the selection of the specific feed item.

In some example embodiments, the content consumption data may be stored in a storage device maintained during a specific search session.

In some example embodiments, a “search session” may be understood as an exploration unit in which data processing linked to a search term input from the user terminal 10 is continuously performed. Such a search session may be formed based on a search term unit. In some example embodiments, based on a specific search term being input (or searched or received) from the user terminal 10, a search session corresponding to the specific search term may be activated (started) by the system 100.

Further, in some example embodiments, while the search session is maintained, data processing such as content search, recommended search keyword generation, feed item provision, and user content (or feed) consumption related to the specific search term may be linked and processed.

In some example embodiments, the search session is maintained when exploration actions for content and feed items corresponding to a specific search term are continuously performed.

For example, in some example embodiments, the search session may be maintained in case where, in a state in which the content or the feed item is provided on the service page 300 as a search result corresponding to the specific search term, a user input (a scrolling operation, etc.) is received. Further, in some example embodiments, the search session may be maintained in case where, based on at least one of the provided content or feed items being selected, an online post corresponding to the selected content or feed item is provided on the service page 300. That is, even when a user consumes the content or the feed item provided as a search result, the search session may be maintained. Further, in some example embodiments, even when returning back to the service page 300 including the search result after the content or the online post is consumed, the search session may be maintained.

Meanwhile, in some example embodiments, the search session may be terminated when a search for a new search term different from the specific search term is performed, when the service page 300 where the search result of the specific search term is provided is exited (e.g., accessing an external link), when the browser or application is closed, when the browser tab is closed, or when a desired (or, alternatively, a predetermined) time elapses (e.g., 20 minutes).

Further, in the storage unit 120, online posts may exist to be stored. In some example embodiments, the “online post” may include various forms of documents posted online. For example, the online post may include at least one of a blog post, a community post, a video, a news article, or a social media post.

In the storage unit 120, keywords generated based on the online posts may exist. In the storage unit 120, online posts and keywords generated from the online posts may exist to be matched to each other (see FIG. 4).

In some example embodiments, the keyword may be generated using a pre-trained large language model 130. In some example embodiments, the online post may be processed as an input to the pre-trained large language model 130.

The large language model 130 may generate a keyword corresponding to the online post. The large language model 130 may analyze at least one of a title, content, video, image, emoji, comment, and review of the online post, and may generate a keyword representing the online post based on the analysis content.

In some example embodiments, information on the online post and a keyword corresponding to the online post are matched and may be provided on the service page 300 as a feed item. Further, in some example embodiments, in response to a keyword included in a feed item being selected, a re-search result for the corresponding keyword may be provided to the service page 300.

That is, in some example embodiments, a keyword generated based on the online post is provided to the user through the feed item, and may be referred to as a “recommended search keyword”.

The large language model 130 may update the keyword corresponding to the online post. The large language model 130 may update the keyword corresponding to the online post based on a user response to the recommended search keyword. For example, in the large language model 130, search frequency information (or user selection frequency information on the recommended search keyword) of the recommended search keyword during a desired (or, alternatively, a predetermined) period may be further processed as an input. The large language model 130 may update the keyword of the online post to another keyword based on the search frequency information of the recommended search keyword during the desired (or, alternatively, the predetermined) period.

Further, a ranking model 140 may refer to a model for calculating a ranking of a plurality of online posts.

In some example embodiments, a preset ranking model 140 may refer to a model for calculating an exposure priority ranking (or ranking score) for each of the plurality of online posts by analyzing (evaluating) relevance (or relatedness) among a search term, the online post, and the user's content consumption data. In some example embodiments, the ranking model 140 may be implemented as a neural ranking model trained with a search term of the user, content features of the online post, and user history-based features (click history, residence time, recently viewed content, etc.) as inputs. In some example embodiments, a feed item provided to the service page 300 may be dynamically specified based on a ranking of the online post calculated by the ranking model 140.

The control unit 150 may be configured to control the components described above overall. The control unit 150 may also be referred to as a processor. The control unit 150 may perform a role of providing content corresponding to a search term received from the user terminal 10 as a search result. Meanwhile, although not illustrated, the control unit 150 may also be referred to as a “search unit”, or it is also possible that a configuration of the “search unit” is further included in the control unit 150. The search unit, as a configuration that performs a role of searching for content for a search term received from the user terminal, will hereinafter be described integrally as the control unit without distinction between the configuration of the control unit and the search unit.

The control unit 150 may search for content corresponding to the search term, using a search engine 200.

In some example embodiments, the “search engine” 200 may refer to a module or a program component executed on a server, which performs a function of searching for content corresponding to a search term received from the user terminal 10 and providing the search result thereof. The search engine 200 may be implemented by the system 100 for providing search services according to some example embodiments. In addition, the search engine 200 may be configured to include at least one of a search server 200a that performs a content searching function or a database (DB) 200b in which content to be provided as a search result is stored. In this case, the system 100 for providing search services may search for content corresponding to the search term by being linked to the search server 200a and the database (DB) 200b, and may provide the search result thereof. In some example embodiments, the search engine 200 may exist in an external cloud environment, but example embodiments are not limited thereto. For example, in some example embodiments, the search engine 200 may be implemented as an internal component included in the system 100 for providing search services.

The control unit 150 may be linked to the search engine 200 to search for content corresponding to a search term received from the user terminal 10 and may control to provide the search result to a content area of the service page 300.

The control unit 150 may generate a feed item, using an online post. As described above, in the storage unit 120, keywords generated from online posts may be matched and stored. The control unit 150 may generate a feed item as a recommended search keyword for the user, using a keyword matched to the online post. That is, the control unit 150 may recommend a search keyword for a new interest that the user may be interested in, together with feed exploration for the online post.

Hereinafter, a more detailed description will be made of a method of providing search services according to some example embodiments.

As illustrated in FIG. 2, in the method of providing search services according to some example embodiments, in operation S210, the system 100 may receive a search term from a user terminal.

In operation S220, the system 100 may search for content corresponding to the search term using a search engine. For example, the control unit 150 may search for information on the search term received from the user terminal. The search term may be input from the user terminal through the search service page 300 provided by the system for providing search services according to some example embodiments.

The control unit 150 may search for content for the search term, using a search engine. In some example embodiments, the content for the search term may include corresponding information. Particularly, in some example embodiments, the content for the search term may include information that the user wants to obtain through a search for the search term.

The control unit 150 may search for content having high relevance with the search term, using the search engine. For example, it is assumed that the search term is “riding a bike.” The control unit 150 may search for content including information on the definition, effects, advantages and disadvantages of riding a bike, or places good for riding a bike.

In operation S230, the system 100 may provide the content as a search result for the search term in a certain area of a service page.

As illustrated in FIG. 3A, the control unit 150 may search for content corresponding to the search term (e.g., “riding a bike”) received through the service page 300, and may provide the content 301 and 302 as a search result to a certain area 300a of the service page 300. In some example embodiments, the certain area 300a of the service page 300 in which the content 301 and 302 is provided may be referred to as a “content area.” The control unit 150 may provide, as a search result, various types of content such as webpage links, electronic documents (or electronic files), images, videos, text, and specific program pages.

Referring back to FIG. 2, in operation S240, the system 100 may provide a feed including feed items linked to a recommended search keyword having relevance with the search term in an area different from the certain area of the service page.

The control unit 150 may select online posts to be provided as feed items. The control unit 150 may select a plurality of online posts, corresponding to a specific number to be provided together with content, based on a desired (or, alternatively, a preset) selection criterion that determines relevance with the search term.

The control unit 150 may select a plurality of online posts including topics related to the search term, based on at least one of the search term or user information.

Here, the user information may include various types of information such as the user's gender, age, residential area, interest, hobby, and occupation. In addition, the user information may include user history information including at least one of search history data of the user (e.g., search terms searched in the user terminal) or content consumption data of the user.

The control unit 150 may select online posts including related topics capable of expanding the user's interest, materializing the user's interest, or shifting the user's interest for the search term.

The control unit 150 may select, from among the plurality of online posts including related topics related to the search term, online posts to be provided as feed items. The related topics may refer to other topics derivable from the search term.

For example, in case where a search term is “riding a bike,” a related topic may include “a review of a young child successfully riding a bike for the first time.” The control unit 150 may select a plurality of online posts corresponding to these various related topics.

The control unit 150 may generate a plurality of feed items 310, 320, and 330, each corresponding to the plurality of online posts. Further, the control unit 150 may provide the plurality of feed items 310, 320, and 330, each corresponding to the plurality of online posts, to an area 300b different from the content area 300a of the service page 300. In some example embodiments, the area 300b of the service page 300 in which the feed is provided may be referred to as a “feed area.”

The control unit 150 may provide a recommended search keyword having relevance with the search term in the feed area 300b.

As described above, in some example embodiments, the feed refers to a tool for inducing a user's search and content exploration. Further, the feed refers to a content stream including a plurality of feed items, and may be provided in a scrollable list format.

The control unit 150 may generate a feed item such that at least a part of an online post is included.

Here, at least a part of the online post may include at least one of a title, description, link, video, image, thumbnail, posting date, or type information of the online post.

For example, as illustrated in FIG. 3B, the control unit 150 may generate a feed item 310 including a title (“riding a bike by a toddler in a park springtime”) and a thumbnail 410a of an online post.

Further, the control unit 150 may generate a feed item, using a keyword generated based on the online post.

As illustrated in FIG. 4, in the storage unit 120, an online post 420 and a keyword 420b generated from the online post 420 may exist and may be linked to each other.

The control unit 150 may process the online post 420 as an input to a pre-trained large language model 130 and may obtain the keyword 420b corresponding to the online post 420.

In some example embodiments, the large language model 130 may be a model trained to generate a keyword corresponding to the online post. The large language model 130 may analyze at least one of a title, content, video, image, emoji, comment, and review of the online post, and may generate a keyword representing the online post based on the analysis content. For example, for an online post including content about a 3-year-old child successfully riding a four-wheeled bike for the first time, the large language model 130 may generate a keyword “third birthday four-wheeled bike success.”

In case where the keyword (e.g., “third birthday four-wheeled bike success,” 420b) is matched to the online post 420, the control unit 150 may generate a feed item for the online post 420, using at least a part of the online post 420 and the keyword 420b matched to the online post.

As illustrated in FIG. 3B, the control unit 150 may generate a feed item 320 such that a first area 321 of the feed item 320 includes the keyword matched to the online post as a recommended search keyword (e.g., “third birthday four-wheeled bike success,” 420b), and a second area 322 of the feed item 320 includes at least a part of the online post (e.g., the title “riding a bike on third birthday (record of success point in time with four-wheeled bike)” or the thumbnail 420a). Meanwhile, in case where a keyword matched to an online post (e.g., see reference number 410 in FIG. 4) does not exist, the control unit 150 may generate a feed item 310 that is not linked to a recommended search keyword. Such a feed item 310 may include at least a part 410a of the online post.

Meanwhile, in some example embodiments, the feed item may correspond to either a feed item of a first attribute (“standalone feed item” 310) generated based on one online post, or a feed item of a second attribute (“group-type feed item” 320) generated based on at least two online posts.

The control unit 150 may generate one feed item 330, using at least two online posts of the plurality of online posts that are related to each other. In some example embodiments, relevance between online posts may mean that the content of the online posts is semantically related or that the topics corresponding to the online posts are related.

For example, based on online post A (e.g., “bike hotspots,” reference number “431” in FIG. 4) and online post B (e.g., “recommendation for cherry blossom bike road,” reference number “432” in FIG. 4) being related to each other, the control unit 150 may generate one feed item 330 using online post A 431 and online post B 432. Such a feed item 330 may also be referred to as a “group-type feed item.”

In this case, the control unit 150 may select a group keyword representing the at least two online posts 431 and 432. The control unit 150 may analyze semantic similarity of content of at least two online posts 431 and 432 based on the large language model 130. The control unit 150 may select a group keyword (e.g., “places good for riding a bike”) based on the semantic similarity analysis using the large language model 130. Further, the control unit may generate a group-type feed item, using the two online posts 431 and 432 and the group keyword.

For example, as illustrated in FIG. 3B, the control unit 150 may generate the group-type feed item 330 such that a first area 331 of the group-type feed item 330 includes the group keyword (“places good for riding a bike,” 430). Further, the control unit 150 may generate the group-type feed item 330 such that a second area 332 of the group-type feed item 330 includes information 431a and 432a of each of at least two online posts. A more detailed description of the group keyword will be provided below.

Meanwhile, in some example embodiments, a feed item may correspond to one of a first type of feed item or a second type of feed item according to whether the recommended search keyword is linked.

In some example embodiments, the first type of feed item may refer to feed items 320 and 330 to which the recommended search keyword 420b and 430 is linked. In the first type of feed item 320 and 330, the recommended search keyword 420b and 430 linked to the first type of feed item 320 and 330, and at least a part of the content 420a, 431, and 432 of the online post corresponding to the first type of feed item may be included together. Further, the first type of feed item 320 and 330 may be linked to a search service for the recommended search keyword and an information providing function for the online post. That is, the first type of feed item 320 and 330 may provide a search result for the recommended search keyword 420b and 430. In addition, the first type of feed item 320 and 330 may provide information on the online post.

In some example embodiments, the second type of feed item may correspond to a feed item 310 to which a recommended search keyword is not linked. The second type of feed item 310 may include at least a part 410a of the content of the online post corresponding to the second type of feed item. Such a second type of feed item 310 may also be understood as being configured with only a first area including at least a part of the online post.

The control unit 150 may receive, through the user terminal 10, a user selection of a specific feed item among the feed items. The control unit 150 may, in response to the user selection, provide content related to the specific feed item on the service page 300.

In this case, the control unit 150 may provide different content to the user terminal 10 according to which of the first area 321 or the second area 322 of the specific feed item 320 was selected by the user selection.

As illustrated in FIG. 5A, the control unit 150 may receive the user selection of the first area 321 of the specific feed item 320 by the user selection. The control unit 150 may, in response to the user selection of the first area 321, set a specific recommended search keyword (e.g., “third birthday four-wheeled bike success,” 420b) matched to the specific feed item 420 as a new search term.

The control unit 150 may provide a search service for the new search term. For example, the control unit 150 may input the specific recommended search keyword 420b to the search engine, and may extract content related to the specific recommended search keyword 420b from the search engine. Further, as illustrated in FIG. 5B, the control unit 150 may provide content 511 and 512 related to the specific recommended search keyword 420b to the service page 300 as a search result for the specific recommended search keyword 420b.

In this case, the content 511 related to the specific recommended search keyword 420b, which is provided as the search result, may include information on the specific online post 420 corresponding to the specific feed item 320.

The control unit 150 may provide the content 511 and 512 related to the specific recommended search keyword 420b to a content area 510 of the service page 300. In addition, although not illustrated, the control unit 150 may provide a feed including a plurality of feed items having relevance with a specific recommended search keyword 420b to a feed area different from the content area 510 of the service page 300.

Further, as illustrated in FIG. 5C, the control unit 150 may receive a selection of the second area 322 of the specific feed item 320 by the user selection. The control unit 150, in response to the selection of the second area 322, may provide, as illustrated in FIG. 5D, a specific online post 520 corresponding to the specific feed item 320 to the service page 300. That is, when the second area 322 is selected, the control unit 150 may provide the online post to the service page 300 such that the user may use (consume or view) the specific online post. That is, the control unit 150 may load the online post corresponding to the specific feed item 320 based on the selection of the second area 322 of the specific feed item 320, and provide it to the user terminal 10.

Meanwhile, in some example embodiments, based on the user's real-time content consumption data, a new recommended search keyword may be provided among a plurality of feed items within the feed.

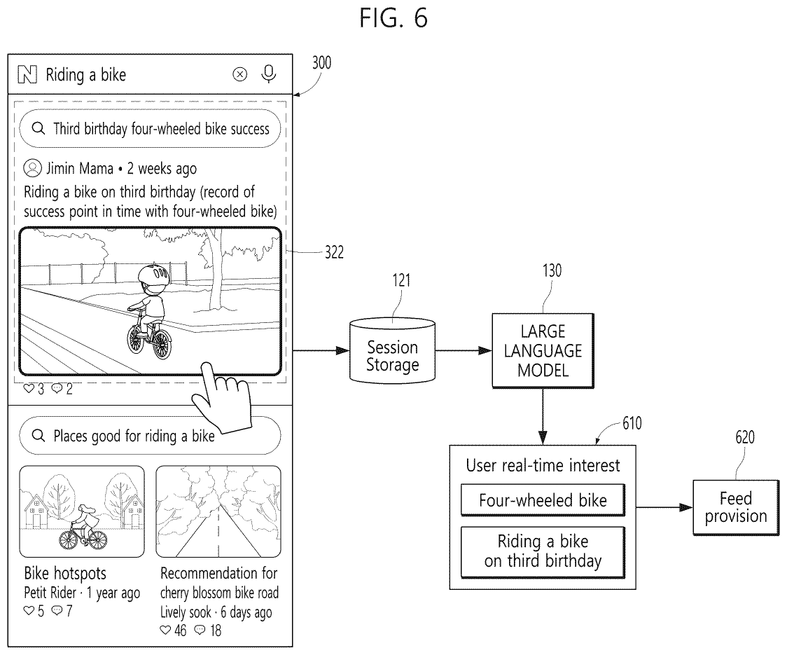

As illustrated in FIG. 6, the control unit 150 may store the content consumption data in a storage device (e.g., Session Storage 121) that is maintained during a specific search session.

As described above, in some example embodiments, the “content consumption data” may include at least one of selection information on a specific feed item selected from among a plurality of feed items provided on the service page 300 in the user terminal 10, and residence time and interaction information in a corresponding online post provided based on the selection of the specific feed item.

In some example embodiments, a “search session” may be understood as an exploration unit in which data processing linked to a search term input from the user terminal 10 is continuously performed. In some example embodiments, the search session may be activated (started) based on the input (or search or reception) of a specific search term (e.g., “riding a bike”) on the user terminal 10. Further, the search session may be terminated when a search for a new search term different from the specific search term is performed (e.g., “camping”), when the service page 300 where the search result of the specific search term is provided is exited (e.g., accessing an external link), when the browser or application is closed, when the browser tab is closed by the user, or when a desired (or, alternatively, a predetermined) time elapses (e.g., 20 minutes).

The control unit 150 may store the content consumption data related to the specific search term in the storage device (e.g., Session Storage 121) while the search session is maintained.

For example, the control unit 150 may store the selection information on the specific feed item 320 in real time as the content consumption data in the storage device (Session Storage 121) based on the selection of the second area 322 of the specific feed item 320. In some example embodiments, the storage device (Session Storage 121) maintained during a specific search session may be understood as a configuration of the storage unit 120.

The control unit 150 may process the content consumption data and the content (online posts) stored in the storage device (Session Storage 121) as an input to the large language model 130 to analyze a real-time interest 610 of the user. In this case, the large language model 130 may specify the user's real-time interest based on the content selected by the user.

The control unit 150 may provide a new feed 620 to the service page 300 so that the user's real-time interest is reflected.

In some example embodiments, the user's real-time interest may mean the user's current interest topic, which is identified in real time through interaction with content or feed items provided to the service page 300 during a specific search session. In some example embodiments, the user's real-time interest may be continuously updated based on the collection of the content consumption data.

In some example embodiments, based on the reception of the search term (e.g., “riding a bike”) from the user terminal 10, a specific search session for the search term may be activated (or started). In the state where the search session is activated, the control unit 150 may select a plurality of online posts corresponding to a specific number (e.g., “three”) to be provided together with content, based on a preset selection criterion that determines relevance with the search term (e.g., “riding a bike”).

The preset selection criterion may vary. For example, the control unit 150 may select a plurality of online posts including topics related to the search term, based on at least one of the search term or user information. As another example, the control unit 150 may select online posts that, although not directly corresponding to the search term, have a high possibility of additionally inducing the user's interest and are expected to gain high attention when exposed to media such as broadcasting.

The control unit 150 may generate a plurality of feed items, each corresponding to the selected plurality of online posts. As described above, the control unit 150 may generate a feed item such that at least one of the online post or a keyword matched to the online post is included. The control unit 150 may generate the feed item by linking the keyword as a recommended search keyword. In this case, according to whether the keyword is matched to the online post, the control unit 150 may generate at least one of a first type of feed item linked to the recommended search keyword or a second type of feed item not linked to the recommended search keyword.

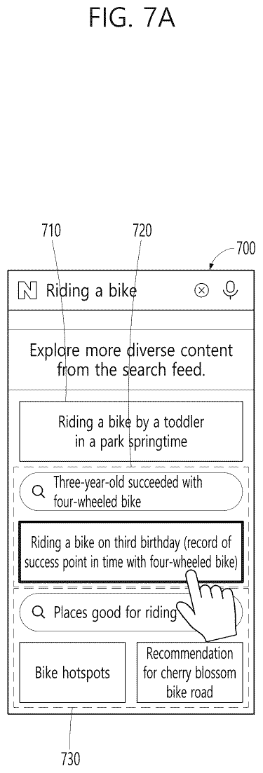

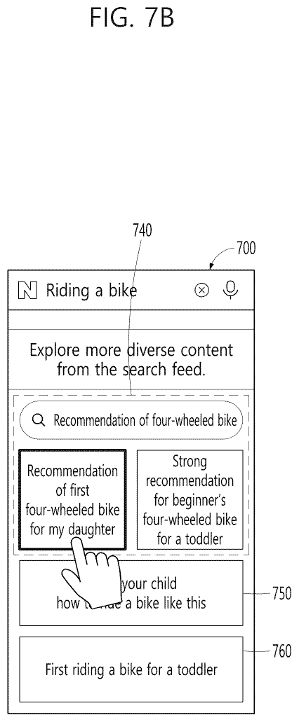

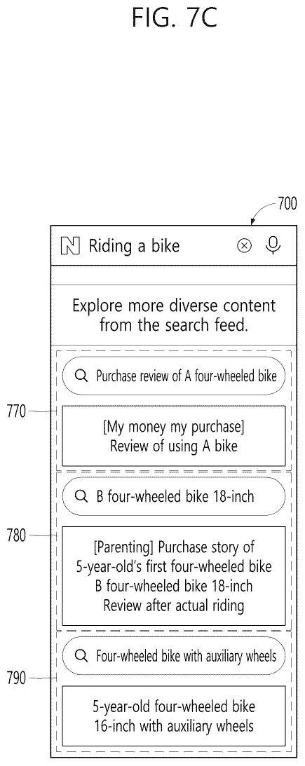

As illustrated in FIG. 7A, the control unit 150 may provide a plurality of feed items 710, 720, and 730 to the service page 700. The control unit 150 may provide a specific number (e.g., “three”) of feed items 710, 720, and 730 to the service page 700. In some example embodiments, the specific number (e.g., “three”) of feed items 710, 720, and 730 may also be referred to as a feed item set. Further, for the convenience of description, the first provided specific number of feed items 710, 720, and 730 may be referred to as a first feed item set.

In the state where the plurality of feed items 710, 720, and 730 are provided, the control unit 150 may collect the user's content consumption data for the plurality of feed items 710, 720, and 730. Further, the control unit 150 may, based on the collected content consumption data, select a new plurality of online posts corresponding to a specific number (e.g., “three”) to be provided in the service page 700 after the plurality of feed items 710, 720, and 730.

That is, the control unit 150 may, based on the user's content consumption data for the first feed item set 710, 720, and 730, select a new plurality of online posts to be provided after the first feed item set 710, 720, and 730.

The control unit 150 may analyze the user's real-time interest from the content consumption data for the first feed item set 710, 720, and 730, based on the large language model 130. Further, the control unit 150 may select a plurality of online posts corresponding to the user's real-time interest.

The control unit 150 may select different online posts depending on which feed item among the plurality of feed items 710, 720, and 730 is selected in the user terminal 10. That is, the control unit 150 may analyze the user's real-time interest depending on which feed item is selected in the user terminal 10. Further, the control unit 150 may select the online posts based on the user's real-time interest.

For example, as illustrated in FIG. 7A, the control unit 150 may, based on the selection of a specific feed item (e.g., “third birthday riding a bike (record of success point in time with four-wheeled bike)”, 720) among the plurality of feed items 710, 720, and 730, select a plurality of online posts related to the specific feed item 720 (e.g., “recommendation of first four-wheeled bike for my daughter,” “strong recommendation for beginner's four-wheeled bike for a toddler,” “teach your child how to ride a bike like this,” “first riding a bike for a toddler, learning to ride a four-wheeled bike”). Although not illustrated, when a feed item 730 different from the specific feed item 720, from among the plurality of feed items 710, 720, and 730, is selected, the control unit 150 may select online posts that are at least partially different from the online posts described above.

As illustrated in FIG. 7B, the control unit 150 may generate a new plurality of feed items 740, 750, and 760, in a number corresponding to a specific number (three), using the selected plurality of online posts. Further, the control unit 150 may provide the new plurality of feed items 740, 750, and 760 to the service page 700.

That is, the control unit 150 may generate a second feed item set 740 to 760 in a number corresponding to a specific number, based on the user's content consumption data for the first feed item set 710, 720, and 730. Further, the second feed item set 740, 750, and 760 may be provided to the service page 700. In this case, the control unit 150 may provide the second feed item set 740, 750, and 760 in succession to the first feed item set 710, 720, and 730.

The control unit 150 may continuously provide feed items corresponding to the user's real-time interest based on the content consumption data, while the specific search session is maintained. The control unit 150 may, based on the user's content consumption data for the second feed item set 740, 750, and 760, select a plurality of online posts to be provided after the second feed item set 740, 750, and 760. Further, as illustrated in FIG. 7C, the control unit 150 may provide new third feed item set 770, 780, and 790 to the service page 700, using the newly selected plurality of online posts.

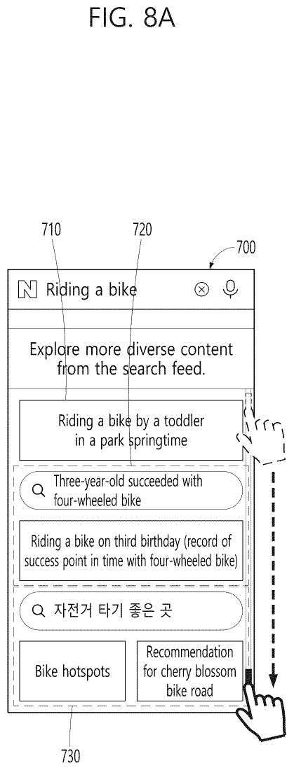

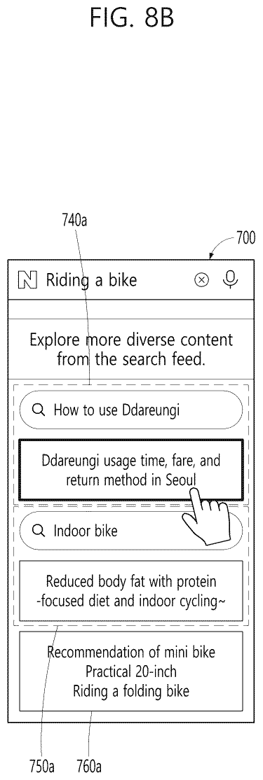

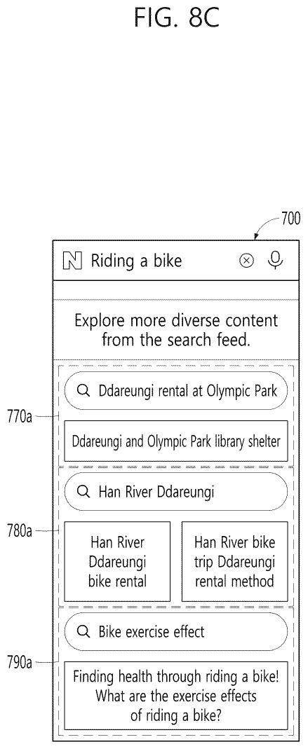

Meanwhile, as illustrated in FIG. 8A, in a state where a plurality of feed items 710, 720, and 730 are provided to the service page 700, a desired (or, alternatively, a predefined) user input (e.g., a scrolling operation) for the service page 700 may be received. In this case, the control unit 150 may select a plurality of online posts related to the search term (e.g., “riding a bike”) and corresponding to a topic different from the plurality of feed items 710, 720, and 730. For example, as illustrated in FIG. 8B, the control unit 150 may select online posts corresponding to topics “how to use Ddareungi (public-use bike),” “indoor bike,” and “mini bike,” and may generate a plurality of feed items 740a, 750a, and 760a each corresponding to the selected online posts.

The control unit 150, when there is no user selection of the first feed item set 710, 720, and 730, may determine that the user has no interest in the topics related to the first feed item set 710, 720, and 730, and may provide a second feed item set 740a, 750a, and 760a related to a new topic to the service page 700. Further, based on the content consumption data for the second feed item set 740a, 750a, and 760a, the control unit 150 may provide new third feed item set 770a, 780a, and 790a to the service page 700, as illustrated in FIG. 8C.

This may support more effective provision of online posts in the subsequent feed that are more suitable to the user's real-time interest, by reflecting the user's content consumption pattern.

As such, the control unit 150 may collect the user's content consumption data during a specific search session, and may analyze the user's real-time interest based on the content consumption data. Further, the control unit 150 may provide online posts corresponding to the user's real-time interest as feed items. These feed items may include a recommended search keyword generated based on the online post, and the control unit 150 may provide the recommended search keyword within the feed according to the user's real-time interest.

Meanwhile, the control unit 150 may determine a ranking of the plurality of online posts, and based on the ranking, may provide a specific number of online posts among the plurality of online posts as feed items to the user.

The control unit 150 may calculate a ranking for the plurality of online posts based on relevance to the search term, through a preset ranking model 140.

In some example embodiments, a preset ranking model 140 may refer to a model for calculating an exposure priority ranking (or ranking score) for each of the plurality of online posts by analyzing (evaluating) relevance (or relatedness) among a search term, the online post, and the user's content consumption data. In some example embodiments, the ranking model 140 may be implemented as a machine learning model based on a neural ranker.

The control unit 150 may process at least two of the search term, the plurality of online posts, or the user information as an input to the ranking model 140, and may calculate a ranking score for the plurality of online posts.

Here, the user information may include various types of information such as the user's gender, age, residential area, interest, hobby, and occupation. In addition, the user information may include user history information including at least one of search history data of the user (e.g., search terms searched in the user terminal) or content consumption data of the user.

The control unit 150 may, based on the search term being input from the user terminal 10, calculate a ranking for the plurality of online posts based on the relevance to the search term.

Further, the control unit 150 may select a specific number of online posts to be provided as feed items among the plurality of online posts, based on the calculated ranking. For example, the control unit 150 may select, from among the plurality of online posts, in a number corresponding to a specific number in an order of highest calculated ranks, as online posts to be provided as feed items.

The control unit 150 may generate feed items, using each of the selected specific number of online posts. The control unit 150 may expose (provide) a plurality of feed items 810 and 820 to the service page 800 according to the ranking of the online posts.

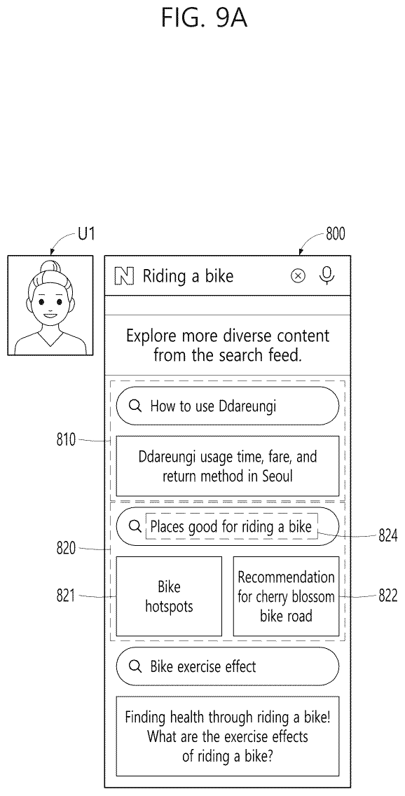

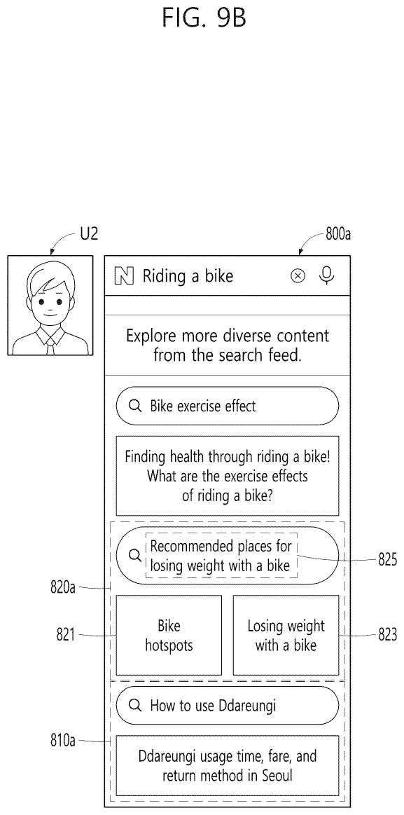

For example, as illustrated in FIG. 9A, the control unit 150 may expose, in the first item, the feed item 810 corresponding to the first rank among the plurality of feed items 810, 820. Further, the control unit 150 may expose, in succession to the feed item 810 corresponding to the first rank, the feed item 820 corresponding to the second rank, and the feed item 830 corresponding to the third rank.

Meanwhile, in the ranking model 140, depending on the user information, the ranking of the plurality of online posts that are based on the relevance to the search term may be calculated differently. The ranking model 140 may determine differently which online posts the user wants to first explore based on the search term, based on the user's search history data, the user's content consumption data, the user's hobbies, gender, age, interests, and the like. For example, the ranking model 140 may calculate the rank of the online post A for a first user (U1) as a highest first rank. In contrast, the ranking model 140 may calculate the rank of the online post A for the first user (U1) as a third rank in a third-level ranking.

The control unit 150 may expose (provide) the plurality of feed items in different orders based on the ranking of the plurality of online posts that are based on the relevance to the search term. For example, as illustrated in FIG. 9A, the control unit 150 may first expose the feed item 810 corresponding to online post A, and may secondly expose the feed item 820 corresponding to online post B, on the service page 800 for the first user (U1). In contrast, as illustrated in FIG. 9B, the control unit 150 may expose the feed item 820a corresponding to online post B prior to the feed item 810a corresponding to online post A, on the service page 800a for a second user (U2).

Meanwhile, when the content consumption data of the user for the plurality of feed items is collected, the ranking model 140 may calculate the ranking of the plurality of online posts based on the user's content consumption data.

The ranking model 140 may calculate the ranking of the plurality of online posts based on the relevance with the specific feed item selected in the user terminal 10 from among the feed items in a number corresponding to a specific number, provided in the service page. In this case, the ranking model 140 may calculate the ranking of the plurality of online posts based on the user's real-time interest analyzed based on the user's content consumption data by the large language model 130.

The ranking model 140 may calculate the order of the online posts according to the user's content consumption pattern and real-time interest, and the control unit 150 may dynamically set the configuration and providing order of the feed items, according to the ranking calculated by the ranking model 140.

In some example embodiments, the feed item may include a recommended search keyword. Further, the recommended search keyword may be generated from the online post. Such a recommended search keyword may be exposed together in linkage to the exposure of the feed item in the service page.

That is, in some example embodiments, based on the relevance between the search term and the online post, it may be determined whether the recommended search keyword linked to the online post is to be exposed to the user as the feed item.

Meanwhile, the control unit 150 may analyze the relevance among the plurality of online posts. Further, the control unit 150 may, based on the relevance among the online posts, determine whether it is necessary to link at least two online posts to generate one feed item.

As illustrated in FIG. 9A, in some example embodiments, the feed item may correspond to either a feed item of a first attribute (“standalone feed item” 810) generated based on one online post, or a feed item of a second attribute (“group-type feed item” 820) generated based on at least two online posts.

The control unit 150 may analyze the relevance among the plurality of online posts, using the large language model 130.

In some example embodiments, relevance among online posts may mean that the content of the online posts is semantically related or that the topics corresponding to the online posts are related.

The control unit 150 may, based on the analysis of relevance among the online posts, specify at least two online posts that are related to each other among the plurality of online posts. For example, when the result of the relevance analysis between a first online post and a second online post satisfies a desired (or, alternatively, a preset) threshold value, the control unit 150 may determine that the first online post and the second online post are related to each other.

The control unit 150 may generate one feed item, using at least two online posts.

The control unit 150 may select a group keyword that represents the first online post and the second online post.

The control unit 150 may select the group keyword based on a semantic similarity analysis using the pre-trained large language model 130 that takes the content of the plurality of online posts as input. For example, as illustrated in FIG. 9A, it is assumed that the content 821 of the first online post is content related to “bike hotspots” and the content 822 of the second online post is content related to “recommendation for cherry blossom bike road”. The control unit 150 may select a group keyword (e.g., “places good for riding a bike”, 824) that represents the first online post and the second online post through a large language model, which takes the content of the first online post and the content of the second online post as input.

The control unit 150 may differently select a group keyword based on at least a part of the online posts related to each other being differently specified. For example, the control unit 150 may differently select a group keyword between a case where a post related to the first online post is the second online post and a case where a post related to the first online post is a third online post different from the second online post.

For example, as illustrated in FIG. 9B, it is assumed that the content 821 of the first online post is related to “bike hotspots”, and the content 823 of the third online post is “losing weight with a bike”. The control unit 150 may select a group keyword (e.g., “recommended places for losing weight with a bike”, 825) that represents the first online post and the third online post through the large language model 130.

Further, the control unit 150 may generate the feed item 820 including the group keyword 824 selected through the large language model 130 and the content 821 and 822 of at least two online posts.

Meanwhile, a keyword may exist to be matched in at least one of the first online post or the second online post. The control unit 150 may generate a new group keyword 824 based on a semantic similarity analysis of the content of the first online post and the content of the second online post, even if a keyword, matched to at least one of the first online post or the second online post, exists, and may allow the group keyword 824 to be included in the feed item 820 as a recommended search keyword. In addition, it is also possible that the control unit 150 selects the keyword matched to at least one of the first online post or the second online post as the group keyword.

The method and system for providing search services according to some example embodiments may support information exploration that reflects a user's query intent in real time to be possible, by receiving a search term from a user terminal, searching for content corresponding to the search term, using a search engine, and providing the content as a search result for the search term in a certain area of a service page.

Further, the method and system for providing search services according to some example embodiments may jointly provide a feed including a feed item linked to a recommended search keyword having relevance to the search term in an area different from the certain area of the service page, so that a user may be provided not only with content corresponding to the search term that the user himself or herself has input, but also with exploratory paths to various related topics expandable from the search term.

Furthermore, the method and system for providing search services according to some example embodiments, based on real-time content consumption data of a user, analyze a context of content within a feed that the user is currently exploring, and provide a recommended search keyword matching the same in real time, so that the user may continuously maintain an exploration flow and easily access information corresponding to the user's real-time interest.

Meanwhile, the computer-readable medium includes all kinds of recording devices for storing data readable by a computer system. Examples of computer-readable media include hard disk drives (HDDs), solid state disks (SSDs), silicon disk drives (SDDs), ROMs, RAMs, CD-ROMs, magnetic tapes, floppy discs, and optical data storage devices.

Further, the computer-readable medium may be a server or cloud storage that includes storage and that the electronic device is accessible through communication. In this case, the computer may download the program according to some example embodiments from the server or cloud storage, through wired or wireless communication.

Further, in some example embodiments, the computer described above may be an electronic device equipped with a processor, that is, a central processing unit (CPU), and is not particularly limited to any type.

Any functional blocks shown in the figures and described above, such as those included in the system 100, may be implemented in processing circuitry such as hardware including logic circuits, a hardware/software combination such as a processor executing software, or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

The method and system for providing search services disclosed herein may integrate advanced machine learning techniques, such as a pre-trained large language model and a neural ranking model, to dynamically generate and prioritize recommended search keywords based on real-time analysis of online post content and user consumption data stored in session-specific storage. This integration enables a technical improvement in search engine functionality by facilitating efficient, context-aware content exploration that adapts in real time to user interactions within a single search session, thereby reducing computational overhead associated with repeated queries and enhancing the precision of information retrieval without relying on static databases. By processing semantic similarities and user history features as inputs to the models, the system allows for seamless transitions to diverse related topics while minimizing latency in feed updates and improving overall system responsiveness.

Furthermore, the session storage for selection information, residence times, and interactions allows the system to perform real-time interest analysis with reduced persistent data overhead. This approach addresses technical challenges in traditional search systems, such as information overload and irrelevant recommendations, by generating group-type feed items, which consolidates related online posts into cohesive units and streamlines the user interface for more effective navigation and discovery.

Meanwhile, it should be appreciated that the detailed description is interpreted as being illustrative in every sense, not restrictive. The scope of the example embodiments should be determined on the basis of the reasonable interpretation of the appended claims, and all of the modifications within the equivalent scope of the example embodiments belong to the scope of the example embodiments.

What is claimed is:

1. A method of providing search services, the method comprising:
receiving a search term from a user terminal;
searching for content corresponding to the search term, using a search engine;
providing the content as a search result for the search term in a first area of a service page; and
providing a feed including feed items linked to a recommended search keyword relevant to the search term, in a second area of the service page different from the first area of the service page.

2. The method of claim 1, further comprising:
generating the feed items based on an online post matched to the recommended search keyword such that a first area of the feed items includes the recommended search keyword, and a second area of the feed items includes at least a part of the online post.

3. The method of claim 2, further comprising:
receiving, from a user terminal, a user selection of a specific feed item among the feed items; and
providing content related to the specific feed item to the service page, in response to the user selection by providing different content according to which one of the first area or the second area of the specific feed item is selected by the user selection.

4. The method of claim 3, wherein the providing of the content related to the specific feed item comprises:
when the first area is selected by the user selection,
setting a specific recommended search keyword matched to the specific feed item as a search term;
inputting the specific recommended search keyword to the search engine, and extracting content related to the specific recommended search keyword from the search engine; and
providing the content related to the specific recommended search keyword to the service page as a search result for the specific recommended search keyword.

5. The method of claim 4, wherein the content related to the specific recommended search keyword provided as the search result includes information on a specific online post corresponding to the specific feed item.

6. The method of claim 3, wherein the providing of the content related to the specific feed item comprises:
providing a specific online post corresponding to the specific feed item to the service page, when the second area is selected by the user selection.

7. The method of claim 1, wherein the feed items provided in the providing of the feed include at least a part of a first type of feed item corresponding to a feed item linked to a recommended search keyword or a second type of feed item corresponding to a feed item not linked to a recommended search keyword.

8. The method of claim 7, wherein
the first type of feed item includes the recommended search keyword linked to the first type of feed item, and at least a part of content of an online post corresponding to the first type of feed item, and
the second type of feed item includes at least a part of content of an online post corresponding to the second type of feed item.

9. The method of claim 1, wherein the providing of the feed items comprises:
selecting a plurality of online posts corresponding to a specific number to be provided with the content, based on a selection criterion indicating a relevance to the search term;
generating a plurality of feed items, each corresponding to the plurality of online posts; and
providing the plurality of feed items.

10. The method of claim 9, wherein the providing of the feed items further comprises:
collecting content consumption data for the plurality of feed items; and
selecting a new plurality of online posts corresponding to the specific number to be provided on the service page after the plurality of feed items, based on the content consumption data.

11. The method of claim 10, wherein the selecting of the new plurality of online posts comprises:
selecting different online posts depending on which feed item among the plurality of feed items is selected via the user terminal.

12. The method of claim 10, wherein the content consumption data is stored in a storage device maintained during a specific search session.

13. The method of claim 12, wherein the content consumption data includes at least one of selection information for a specific feed item selected in the user terminal among the plurality of feed items, or a residence time and interaction information in a corresponding online post provided based on the user selection of the specific feed item.

14. The method of claim 9, wherein the providing of the feed comprises:
analyzing relevance among the plurality of online posts;
specifying at least two online posts related to each other among the plurality of online posts, based on the relevance analysis;
selecting a group keyword representing the at least two online posts; and
generating feed items that respectively include content of the at least two online posts, together with the group keyword.

15. The method of claim 14, wherein the analyzing of the relevance and the selecting of the group keyword are performed based on a semantic similarity analysis using a large language model, which takes content of the plurality of online posts as input.

16. The method of claim 1, wherein the providing of the feed comprises:
calculating a ranking for a plurality of online posts based on relevance to the search term, through a ranking model;
selecting a specific number of online posts to be provided as the feed items from among the plurality of online posts, based on the calculated ranking; and
generating the feed items, using each of the specific number of online posts.

17. A system for providing search services, comprising:
a memory; and
at least one processor configured to execute instructions stored in the memory to configure the system to:
receive a search term from a user terminal;
search for content corresponding to the search term using a search engine;
provide the content as a search result for the search term in a first area of a service page; and
provide a feed including feed items linked to a recommended search keyword having relevance to the search term, in a second area of the service page different from the first area of the service page.

18. A non-transitory computer-readable recording medium storing a program that, when executed by one or more processes in an electronic device, configures the electronic device to perform:
receiving a search term from a user terminal;
searching for content corresponding to the search term using a search engine;
providing the content as a search result for the search term in a first area of a service page; and
providing a feed including feed items linked to a recommended search keyword having relevance to the search term, in a second area of the service page different from the first area of the service page.
